(19) United States
(12) Patent Application Publication
(10) Pub. No.: US 2023/0212894 A1
(43) Pub. Date: Jul. 6, 2023

(54) DOOR BRACKET ASSEMBLY

(71) Applicant: Qianwen Deng, Union City, CA (US)

(72) Inventor: Qianwen Deng, Union City, CA (US)

(21) Appl. No.: 17/569,521

(22) Filed: Jan. 6, 2022

(51) Int. Cl. E05C 19/00

(52) U.S. Cl. CPC E05C 19/003

(57) ABSTRACT

The present invention discloses a door bracket assembly in a locked and unlocked position according to a door situation of the either being closed or open. The door bracket includes a locking assembly to perform a locking mechanism with a pair of locking elements. The pair of locking elements is in a first position, where the locking mechanism is disengaged and the door bracket is unlocked. In a second position, where the locking mechanism is engaged and the sliding door latch is locked.

### FIELD OF INVENTION

The present invention generally relates to systems and methods for locking a door. More specifically, the present invention is directed to a door bracket assembly which has the capabilities of hanging multiple utility items.

### BACKGROUND OF THE INVENTION

The door barricading or door locking is not a new field. Traditionally the door locks are a cross bar that pivots from a hinge assembly and is mounted to a door frame. Further, barricade the door, the cross bar pivots down to engage a locking brace that is attached to another part of the door frame.

Other door locks include the latch type locking mechanism or the screw type locking mechanism which needs a lot of strength to complete the mechanism.

An issued U.S. Pat. No. 10,125,525 assigned to Michael Presutti discloses a lock positioned on one side of the door. The lock is fixed on one axis and the other axis is pivotal for latching the door. Though the patent discloses a system that is easy to use still it fails to provide a secured locking as the other side of the door is not secured.

Another US patent application 20210324667 assigned to Maglock llc discloses a lock system for a door. The lock system engages or locks the door from both sides with a sliding member. The system includes a sliding member to extend the first end to the second end and a locking bolt moving outward to do the final locking. Although, the invention is advancement to the prior invention as it provides the locking from both the sides of the door. Still the system fails to provide a easy to use and affordable locking system.

The present invention seeks to provide an improvement in the field door locking, more specifically, but not exclusively, in the field of door locking with additional features. The devices in the prior art are difficult to use, an elderly or a person in a wheelchair. The prior art devices either not provide complete security still would likely prove inadequate. As operating these devices is complicated and may be unsafe, thereby increasing the likelihood that a door will not be barricaded in time to prevent an intruder from entering the room.

Therefore to overcome the shortcomings of the prior-arts, there is a need to provide a door locking assembly to provide easy accessibility. Moreover, the door locking assembly is provided to secure the door from both sides. In view of the foregoing inventions, there is a need in the art for providing more security with multiple hangers to hang any utility item to overcome or alleviate the before mentioned shortcomings of the prior arts.

It is apparent now that numerous methods and systems are developed in the prior art that are adequate for various purposes. Furthermore, even though these inventions may be suitable for the specific purposes to which they address, accordingly, they would not be suitable for the purposes of the present invention as heretofore described. Thus, there is a need for an advanced and accessible door locking assembly.

### SUMMARY

A door bracket assembly in a locked and unlocked position in accordance with the door situation of the either being closed or open. The door bracket assembly includes a bracket and a pair of side panels. The bracket includes a locking assembly to perform a locking mechanism with a pair of locking elements. The pair of locking elements is in a first position, where the locking mechanism is disengaged and the door bracket is unlocked. In a second position, where the locking mechanism is engaged and the sliding door latch is locked.

The primary objective of the present invention is to provide a door bracket assembly for locking a door from one side or from two sides. The door bracket assembly includes a bracket and a pair of side panels. The bracket includes a base plate affixed to the door via multiple affixing members and a locking assembly positioned on the base plate. The locking assembly includes a pair of locking elements opposite to each other, where each of the pair of locking elements includes a slider track, a slider and a thumb screw. The thumb screw attached to the slider is helpful for sliding the slider within the slider track.

A pair of side panels positioned opposite to each other on a frame of the door. The pair of the side panels includes a groove to receive the slider from the pair of locking elements to lock the door.

Moreover the locking assembly includes one or more hangers on at least one side of the pair of locking elements.

The other objective of the present invention is to provide a bracket which is positioned at centre of the door through the affixing members. The affixing members can include nails, screws etc. In a preferred embodiment, the nails or screws can be replaced by some adhesive including glue, epoxy, epoxy resin etc.

Another objective of the present invention is to provide a thumb screw which is perpendicularly attached to the slider and the slider track is a horizontal groove for sliding the slider in between. The thumb screw slides the slider to be received by the groove of the side panel to lock the door. The thumb screw on the slider serves as a locking mechanism and user interaction feature for adjusting position of the slider. In one embodiment, the slider is of beam geometry. The beam geometry allows reinforcement of the slider within the side panels.

Another objective of the present invention is to provide a pair of side panels affixed on the door frame with multiple nails or screws.

Yet another objective of the present invention is to provide a number of hangers positioned on the slider track to hang either clothes or tools.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

Although, the invention is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent.

### BRIEF DESCRIPTION OF DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1A illustrates a perspective image of door bracket assembly for locking a door from two sides;

FIG. 1B illustrates the door bracket assembly for locking a door from two sides;

FIG. 1C illustrates a perspective image of door bracket assembly for locking a door from one side;

FIG. 1D illustrates the door bracket assembly for locking a door from one side;

FIG. 2A illustrates a front view of the door bracket assembly in an unlocked configuration;

FIG. 2B illustrates a perspective view of the door bracket assembly in the unlocked configuration;

FIG. 3A illustrates a front view of the door bracket assembly in a locked configuration; and

FIG. 3B illustrates a perspective view of the door bracket assembly in the locked configuration.

### DETAILED DESCRIPTION

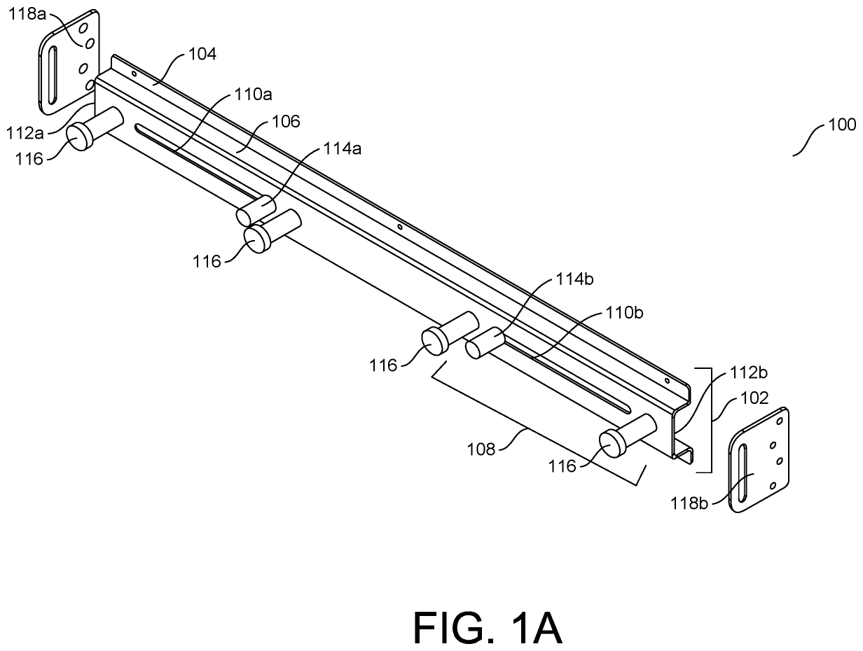

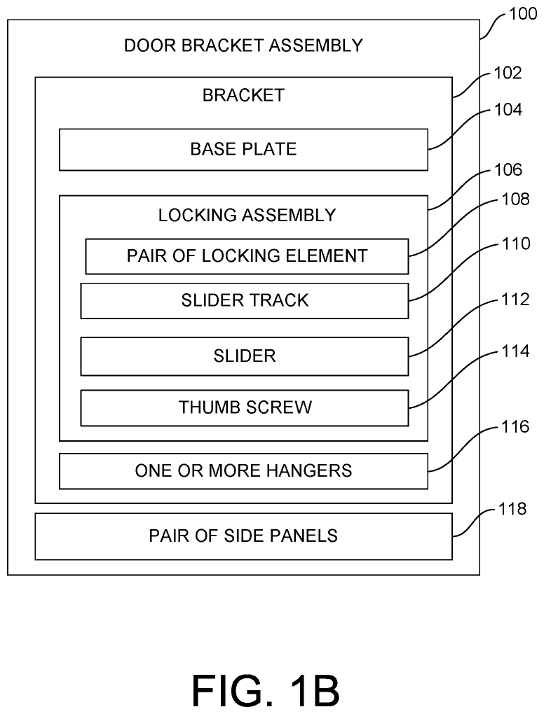

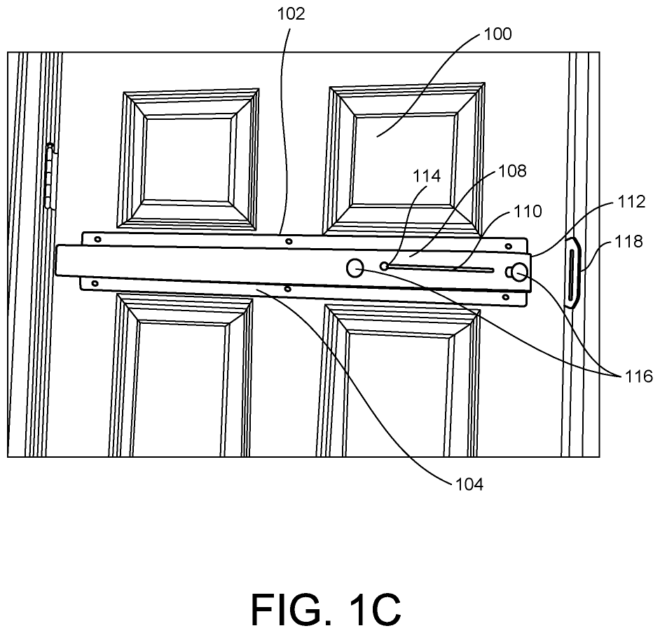

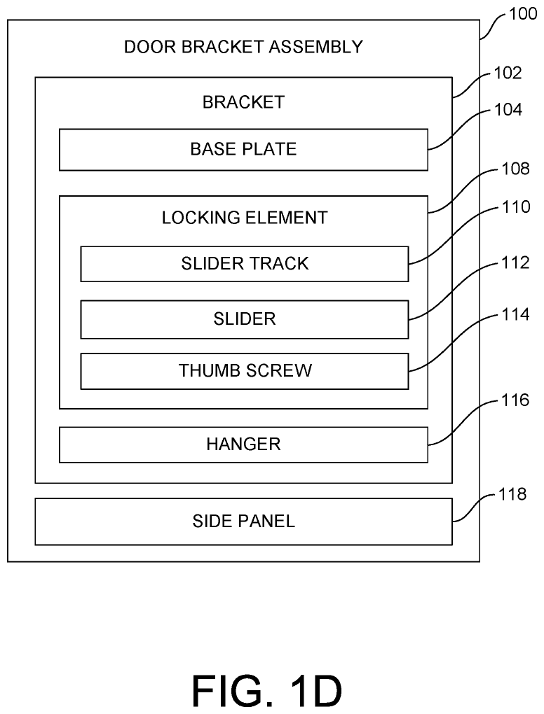

FIG. 1A illustrates a perspective image of door bracket assembly 100 for locking a door from two sides. The door bracket assembly 100 includes a bracket 102 and a pair of side panels 118. The bracket 102 includes a base plate 104 and a locking assembly 106 to perform a locking mechanism with a pair of locking elements (108A, 108B). The pair of locking elements (108A, 108B) is in a first position, where the locking mechanism is disengaged and the door bracket is unlocked. In a second position, where the locking mechanism is engaged and the sliding door latch is locked.

Generally, the door bracket assembly is either of a lock, a latch or a barricade. Preferably, the door bracket assembly is made from stainless steel. Alternatively, the door bracket assembly is made either from aluminum, iron, alloy or polymer.

The door bracket assembly 100 for locking a door includes a bracket 102 and a pair of side panels (118A, 118B). The bracket 102 is affixed on backside of the door. Moreover, the bracket is placed horizontally towards the center. The bracket 102 includes a base plate 104, a locking assembly 106 and multiple hangers 116.

Preferably, the bracket 102 is placed horizontally for locking the door from both left and right sides. Alternatively, the bracket is placed vertically for locking the door from upside down.

The base plate 104 is the bottom portion of the door bracket assembly which is affixed to the door with a number of affixing member. Generally, the affixing members are nails or screws of steel, iron or alloy.

The locking assembly 106 is fixed over the base plate 104 via a permanent means like welding. The locking assembly 106 includes a pair of locking elements 108. The pair of locking elements 108 further includes a slide track 110, a slider 112 and a thumb screw 114. The slider track 110 is a horizontal groove for sliding the slider 112 in between. The thumb screw 114 is attached to the slider 112 for sliding within the slider track 110.

The multiple hangers 116 are positioned on each side of the pair of locking elements 108. Preferably, the multiple hangers 116 are used to hang clothes etc. Alternatively, the multiple hangers are used to hang tools.

In primary embodiment the material of the multiple hangers is same as of the pair of locking elements. In an alternative embodiment the material of the multiple hangers is different as of the pair of locking elements. Where the element is either of stainless steel, iron, aluminum or alloy.

The pair of side panels (118A, 118B) positioned opposite to each other on a frame of the door. Each of the pair of the side panels includes a groove to receive the slider 112 from the pair of locking elements (108A, 108B) to lock the door. The pair of side panels are affixed on the door frame with a nail or screw. In one embodiment of the invention, the nails or screws can be replaced by some adhesive including glue, epoxy, epoxy resin etc.

Moreover, the thumb screw (114A, 114B) slides the slider to be received by the groove of the side panel to lock the door. The thumb screw on the slider serves as locking mechanism and user interaction feature for adjusting position of the slider. When, user pushes the thumb screw from one side to the other. The slider (112A, 112B) is brought in an engaged or locked position or in a disengaged or unlocked position. In one embodiment, the slider (112A, 112B) is of beam geometry. The beam geometry allows reinforcement of the slider (112A, 112B) within the side panels.

In primary embodiment the bracket assembly is for locking a door. Alternatively, the bracket assembly is for locking window or else.

FIG. 1B illustrates the door bracket assembly for locking a door from two sides. The door bracket assembly 100 for locking a door includes a bracket 102 and a pair of side panels 110. The bracket includes a base plate, a locking assembly and multiple hangers.

The base plate 104 is the bottom portion of the door bracket assembly which is affixed to the door with a number of affixing member. Generally, the affixing members are nails or screws of steel, iron or alloy.

The locking assembly 106 is fixed over the base plate. The locking assembly includes a pair of locking elements (108A, 108B). The pair of locking elements (108A, 108B) further includes a slide track (110A, 110B), a slider (112A, 112B) and a thumb screw (114A, 114B). The thumb screw 114 is attached to the slider 112 for sliding within the slider track 110. The multiple hangers 116 are positioned on each side of the pair of locking elements.

The pair of side panels (118A, 118B) positioned opposite to each other on a frame of the door. Each of the pair of the side panels includes a groove to receive the slider from the pair of locking elements to lock the door. The pair of side panels are affixed on the door frame with a nail or screw.

Moreover, the thumb screw slides the slider to be received by the groove of the side panel to lock the door.

FIG. 1C illustrates a perspective image of door bracket assembly for locking a door from one side. A door bracket assembly is either a locking assembly or a barricade assembly. The door bracket assembly 100 includes a bracket 102 and a side panel 118.

The bracket 102 is attached to the door horizontally towards the center. The bracket 102 includes a base plate 104 and a locking element 108. The base plate 104 is affixed to the door via a plurality of screws or nails. In one embodiment of the invention, the nails or screws can be replaced by some adhesive including glue, epoxy, epoxy resin etc.

The locking element positioned on the base plate. The locking element 108 includes a slider track 110, a slider 112 and a thumb screw 114. The slider track 110 includes a horizontal groove to provide a passage. The thumb screw 114 attached to the slider for sliding within the slider track.

There are a number of hangers on either side of the locking element for hanging utility items. Where the utility the items are either of clothes or tools. The number of hangers varies from one to four.

The side panel 118 is positioned on a frame of the door. The side panel includes a groove to receive the slider to lock the door from one side.

Particularly, the hanger 116 is positioned on either side of the locking element. More particularly, a pair of hanger is positioned on each side of the locking elements.

FIG. 1D illustrates the door bracket assembly for locking a door from one side. The door bracket assembly 100 includes a bracket and a side panel. The bracket 102 is attached to the door horizontally towards the center. The bracket includes a base plate 104 and a locking element 108. The base plate is affixed to the door via a plurality affixing members.

The locking element positioned on the base plate. The locking element includes a slider track 110, a slider 112 and a thumb screw 114. The thumb screw attached to the slider for sliding within the slider track.

One or more hangers 116 is placed on at least one side of the locking element for hanging clothes or tools. The number of hangers varies from one to many.

The side panel is positioned on a frame of the door. The side panel 118 includes a groove to receive the slider to lock the door from one side.

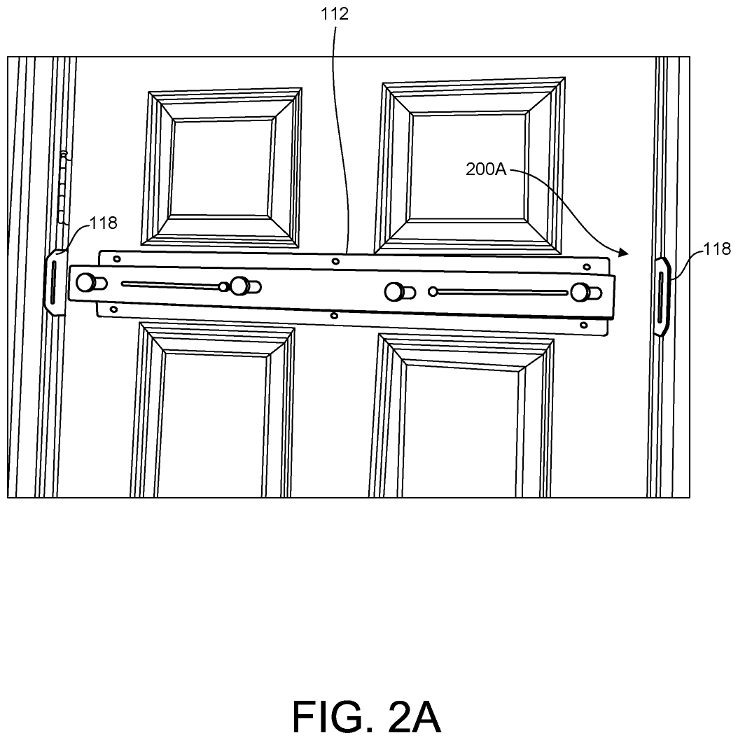

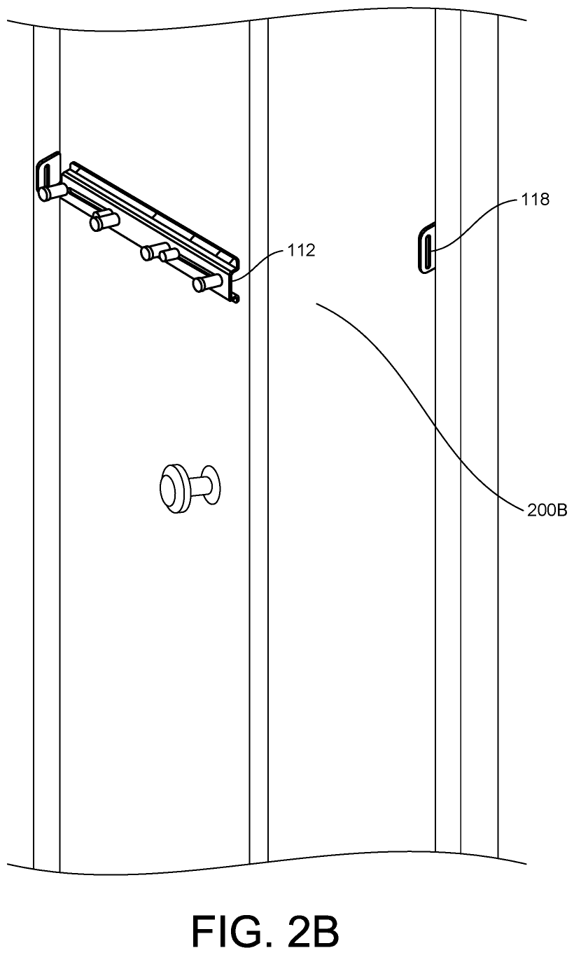

FIG. 2A illustrates a front view of the door bracket assembly in an unlocked configuration 200A. The front view of the door bracket assembly illustrates a bracket configured on the centre of the door horizontally. The base plate of the bracket is affixed to the door via a plurality of affixing members and the locking assembly fixed on the bracket includes a pair of locking member. The pair of locking elements opposite to each other positioned on the base plate including a slider track, a slider and a thumb screw. The thumb screw 114 is attached to the slider 112 for sliding within the slider track.

The slider track is a guide track configured to facilitate movement of one or more components. The slider tracks is formed of any suitable size, shape, and design and is configured to facilitate the operable attachment with and smooth movement of components along the slider tracks. The component is a slider that slides in between the groove of the slider track.

A pair of side panels 118 positioned opposite to each other on a frame of the door. The pair of the side panels includes a groove to engage with the slider from the pair of locking elements to lock the door. Although, in an unlocked configuration the slider and the pair of side panels remains disengaged.

FIG. 2B illustrates a perspective view of the door bracket assembly in the unlocked configuration 200B. The door bracket assembly is formed of any suitable size, shape, and design and is configured to facilitate side to side movement of the slider 112 along the length of the slider track.

In the arrangement shown, as one example, the pair of locking assembly has a front, a rear, a top, a bottom, and opposing sides. In the arrangement shown, as one example, the bracket has a generally elongated shape extending between the opposing sides of the door. In this example arrangement, the slider track has slide features positioned in the rear of the bracket. Slide features of slider track are configured to ride within the guide track and facilitate lateral side to side movement of the thumb screw 114 along the guide track.

In one arrangement, for example, the door locking assembly are formed of a high strength metallic material (e.g., steel), a composite material (e.g., fiberglass, carbon fiber, and the like), or a combination thereof.

The perspective view illustrates the unlocked configuration of the door bracket assembly. The sliders are disengaged with the pair of side panels 118 as the sliders are in there static position and not moved.

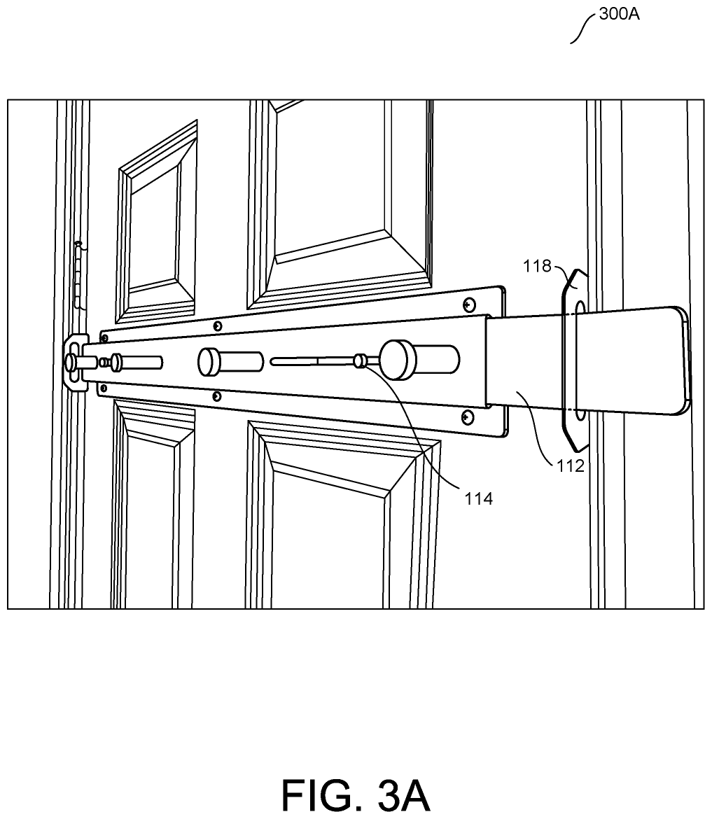

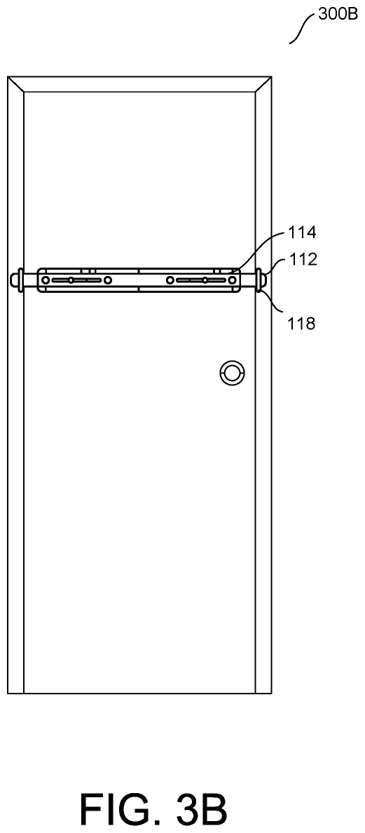

FIG. 3A illustrates a front view of the door bracket assembly in a locked configuration 300A. Slide feature of the slider 112 are configured to ride within the channels of the slider track and facilitate lateral movement of the thumb screw 114 with the slider along the slider track. In the shown arrangement, as one example, slide feature is in form of a groove within the guide track. Alternatively, the slide feature may be included externally from one of the sides of the main body.

The thumb screw on the slider serves as locking mechanism and user interaction feature for adjusting position of the slider 112. To lock the door the user pushes the thumb screw 114 side wise to extend the slider towards the door frame and engage with the pair of side panels 118. In one embodiment, the slider (112A, 112B) is of beam geometry. The beam geometry allows reinforcement of the slider (112A, 112B) within the side panels.

FIG. 3B illustrates a perspective view of the door bracket assembly in the locked configuration 300B. In the arrangement shown, as one example, the pair of side elements includes slider track 110, configured to facilitate movement of one or more sliders of the interior assembly along a length of the bracket. The slider track 110 is formed of any suitable size, shape, and design. Also, they are configured to facilitate the smooth movement of slider 112 with thumb screw 114 along the slider track 110.

In an arrangement shown, as one example, guide tracks are each formed by a respective pair of opposing sliders 112 with the thumb screw 114 in the bracket. For instance, a first slider track includes a first slider in an upper surface of bottom along the thumb screw. In this example arrangement, the second slider track also includes a second slider in a bottom surface of top with the second thumb screw. The sliders are configured to ride within the groove of the guide track and facilitate lateral movement of slider as thumb screw 114 moves along the guide track.

In locked configuration arrangement, the thumb screw 114 is being moved in the opposite direction from the unlocked position to the locked position leading the slider 112 being engaged with the side panels 118 of the groove.

While the various embodiments of the present invention have been described above, it should be understood that they have been presented by way of example only, and not of limitation. Likewise, the figure may depict an example architectural or other configuration for the invention, which is done to aid in understanding the features and functionality that can be included in the invention. The invention is not restricted to the illustrated example architectures or configurations, but the desired features can be implemented using a variety of alternative architecture and configurations.

Although, the invention is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent.

1. A door bracket assembly for locking a door, wherein the door bracket assembly comprising:
a bracket configured on the door, wherein the bracket includes:
a base plate, wherein the base plate is affixed to the door via a plurality of affixing members;
a locking assembly with a pair of locking elements opposite to each other positioned on the base plate, wherein each of the pair of locking elements includes:
a slider track;
a slider; and
a thumb screw attached to the slider for sliding within the slider track; and
one or more hangers on at least one side of the slider track; and
a pair of side panels positioned opposite to each other on a frame of the door, wherein each of the pair of the side panels includes a groove to receive the slider from the pair of locking elements to lock the door.

2. The door bracket assembly in accordance with claim 1, wherein the bracket is positioned at centre of the door through the affixing members.

3. The door bracket assembly in accordance with claim 2, wherein the affixing members are either of nails, screws, glue or adhesive.

4. The door bracket assembly in accordance with claim 1, wherein the thumb screw is perpendicularly attached to the slider.

5. The door bracket assembly in accordance with claim 1, wherein the slider track is a horizontal groove for sliding the slider in between.

6. The door bracket assembly in accordance with claim 5, wherein the thumb screw slides the slider to be received by the groove of the side panel to lock the door.

7. The door bracket assembly in accordance with claim 1, wherein the pair of side panels are affixed on the door frame with a nail or screw.

8. The door bracket assembly in accordance with claim 1, wherein the one or more hangers are positioned on each side of the slider track.

9. The door bracket assembly in accordance with claim 8, wherein the one or more hangers are used to hang either clothes or tools.

10. The door bracket assembly in accordance with claim 1, wherein the thumb screw on the slider serves as locking mechanism and user interaction feature for adjusting position of the slider.

11. The door bracket assembly in accordance with claim 1, wherein the slider is of beam geometry that reinforces the side panels.

12. The door bracket assembly in accordance with claim 1 is a door barricade.

13. A door barricade assembly, wherein the door barricade assembly comprising:
a bracket attached to a door, wherein the bracket includes:
a base plate, wherein the base plate is affixed to the door via a plurality of screws;
a locking element positioned on the base plate, wherein the locking element includes:
a slider track;
a slider; and
a thumb screw attached to the slider for sliding within the slider track; and
a hanger on at least one side of the locking element; and
a side panel positioned on a frame of the door, wherein the side panel includes a groove to receive the slider to lock the door.

14. The door barricade assembly in accordance with claim 13, wherein the hanger is positioned on each side of the locking element.

15. The door barricade assembly in accordance with claim 13, wherein the bracket includes a pair of locking elements positioned on the backside of the door.

16. The door barricade assembly in accordance with claim 15, wherein a pair of hangers are positioned on each side of the locking elements.

17. The door barricade assembly in accordance with claim 13 is a door locking assembly.

18. The door bracket assembly in accordance with claim 13, wherein the door barricade assembly is easily configurable with the door of width ranging from 28 inches to 37 inches.

19. The door bracket assembly in accordance with claim 13, wherein the door barricade assembly prevents a child or a baby from opening the door.
